(19) United States
(12) Patent Application Publication
(10) Pub. No.: US 2007/0288370 A1
(43) Pub. Date: Dec. 13, 2007

(54) PROPRIETARY POINT OF PURCHASE RESOURCE SYSTEM

(76) Inventor: Dolor J. Konja, San Diego, CA (US)

Correspondence Address: LOZA & LOZA LLP, 305 N. SECOND AVENUE, #127, UPLAND, CA, 91786-6064, US

(21) Appl. No.: 11/742,487

(22) Filed: Apr. 30, 2007

Related U.S. Application Data
(63) Continuation-in-part of application No. 10/987,642, filed on Nov. 12, 2004.

(51) Int. Cl. G06Q 40/00

(52) U.S. Cl. 705/41; 705/35; 705/39

(57) ABSTRACT

The disclosure allows consumers to perform various financial transactions from a single source. Consumers are enrolled and pre-approved for services. A card, which may be a pin-based card, is provided to the consumer, which identifies the pre-approved financial services/transactions. The consumer's card is for accessing either an Assisted or Self-Service kiosk. A consumer inserts/swipes the card into a Kiosk and may enter a pin number then a list of services is provided. The consumer selects a service and the Kiosk performs the service if the consumer has been approved for that service. Services include, but are not limited to obtaining a cash-advance. cashing a check, wiring money, obtaining a money order, exchanging foreign currency, paying bills withdrawing money from an ATM, obtaining a pre-paid phone card, obtaining a pre-paid debit card, and others.

This application is a continuation-in-part application of U.S. non-provisional application Ser. No. 10/987,642 filed Nov. 12, 2004.

### FIELD OF THE DISCLOSURE

The disclosure relates to providing consumers with an all in one point of purchase resource system for delivering financial services/transactions.

### BACKGROUND OF THE DISCLOSURE

Every day consumers are faced with the challenge of working full time. raising families and finding the time to run errands, particularly financial services/transactions. To complete all the necessary financial services/transactions, consumers have to go to several different locations. which takes a considerable amount of time. A lot of consumers spend a good portion of their weekend completing these financial services. These financial services/transactions may include obtaining a cash-advance, cashing a check, wiring money, obtaining a money order, exchanging foreign currency, paying bills, withdrawing money from an ATM, obtaining a pre-paid phone card and obtaining a pre-paid debit card.

In addition to having to spend a lot of time going to different locations to perform all the needed financial services/transactions, some consumers do not have bank accounts and credit cards. As a result, it is difficult for these consumers to have access to day-to-day money transactions/exchanges. Therefore, what is needed is a single source that allows consumers to perform various financial services/transactions at one location and allows consumers without a bank account or credit card to have access to the day-to-day money transactions/exchanges.

### SUMMARY OF THE DISCLOSURE

In one aspect of the disclosure, a proprietary point of purchase resource system that allows consumers to perform various services/transactions from a single source is provided. Consumers may enroll directly utilizing the system or consumers may fill out an application for pre-approval of a variety of financial services/transactions. Upon approval, the consumer is provided with a card, which may be embedded with information about the consumer and all the services/transactions for which the consumer has been pre-approved. Alternatively, the consumer information is stored at a remote secured location (server). The card can be any type of card that may store information, such as a smart card, an open loop card, a closed loop card, an ATM card, a debit card, a phone card, a magnetic card, or any other device having the same capability, hereinafter referred to as a “card.” Those skilled in the art will recognize that the principles and teachings described herein may be applied to a variety of applications or industries.

To utilize the services, the consumer uses the card in conjunction with a conveniently located proprietary point of purchase resource system. The resource system may be an All-in-one web-based real-time financial services/transactions suite desktop assisted-service PC platform or a kiosk, hereinafter referred to as “kiosk”. Alternatively, the resource system may be an All-in-one web-based real-time financial services suite fully automated self-service financial kiosks When the card is inserted, or swiped if using a magnetic stripe reader or any other peripheral, the consumer is greeted on a touch screen and is provided a list of services/transactions that may be performed. Alternatively, if the consumer is utilizing an assisted kiosk. a clerk may inquire what services/transactions to perform. Once the consumer selects a service/transaction, the proprietary point of purchase resource system performs the service/transaction if the consumer has been approved for that service/transaction. If the consumer has not been approved for that service/transaction, the consumer can request expedited approval of the service/transaction by asking the clerk (or agent) for assistance or if applicable, using a phone hand set that may be attached to the proprietary point of purchase resource system. Services/transactions may include, but are not limited to, obtaining a cash-advance. cashing a check, wiring money, obtaining a money order, exchanging foreign currency, paying bills, withdrawing money from an ATM, obtaining a pre-paid phone card, obtaining a pre-paid debit card, floral services, car insurance and other services/transactions.

### BRIEF DESCRIPTION OF THE DRAWINGS

The disclosure will be better understood from the following detailed description of an embodiment of the disclosure, taken in conjunction with the accompanying drawings in which like reference numerals refer to like parts and in which:

FIG. 1 is a block diagram of a computing system for executing computer executable process steps according to one embodiment of the disclosure;

FIG. 2 is a block diagram showing the internal functional architecture of the computing system in FIG. 1;

FIG. 3 is a block diagram of a typical topology of a computer network with computers, used according to one embodiment of the disclosure;

FIG. 4 is a block diagram of a proprietary point of purchase resource system for performing multiple financial services/transactions, according to one aspect of the disclosure;

FIG. 5 is a screen shot of a representative example of a transaction report generated from the consumer's transactions using the resource system, according to one aspect of the disclosure;

FIG. 6 is a screen shot of a representative example of a monitoring report of the resource system's machines or terminals, according to one aspect of the disclosure;

FIG. 7 is a screen shot of information used by the resource system s personnel to assist the consumer, according to one aspect of the disclosure;

FIG. 8a is a flow chart illustrating the steps of performing multiple financial services/transaction from a single source. according to one aspect of the disclosure;

FIG. 8b illustrates an example of a screen shot that greets the consumer and asks the consumer to insert a card, according to one aspect of the disclosure;

FIG. 8c illustrates an example of a screen shot that appears after the consumer has successfully logged into the resource system, according to one aspect of the disclosure;

FIG. 8d illustrates an example of a screen shot generated if the consumer is not pre-approved for a service that was selected, according to one aspect of the disclosure;

FIG. 8e illustrates an example of a screen shot instructing the consumer to collect money from a cash dispenser, according to one aspect of the disclosure; and

FIG. 9 illustrates a device or kiosk of one embodiment of the disclosure that allows consumers to perform multiple financial services, according to one aspect of the disclosure.

### DETAILED DESCRIPTION OF THE DRAWINGS

To facilitate an understanding of the disclosure, the general architecture and operation of a computing system will initially be described. The specific architecture and operation of the disclosure will then be described with reference to the general architecture.

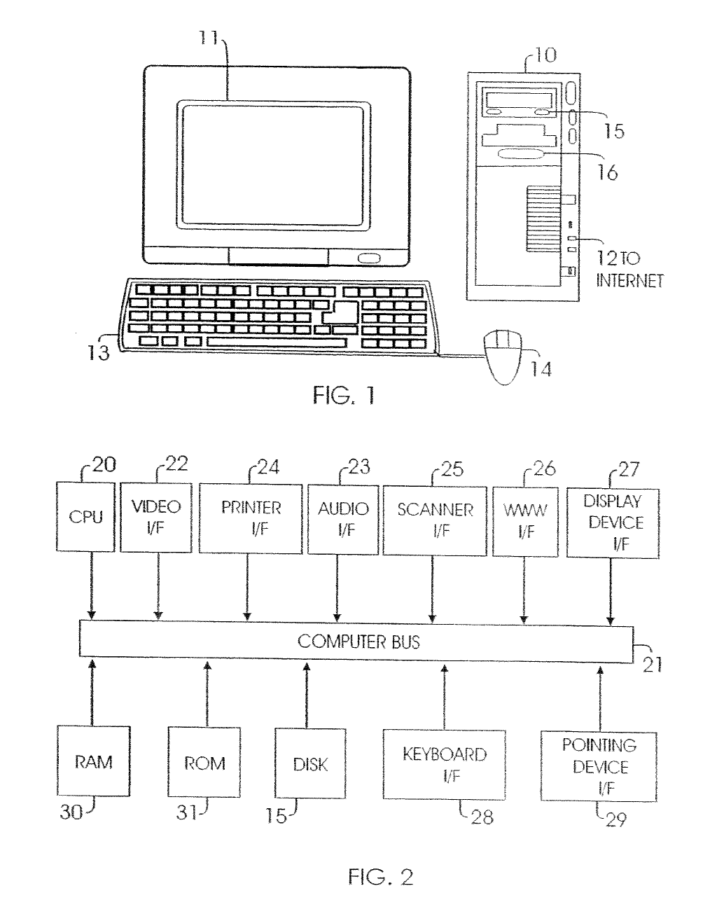

FIG. 1 is a block diagram of a computing system for executing computer executable process steps according to one embodiment of the disclosure. FIG. 1 includes a host computer 10 and a monitor 11. The monitor 11 may be a CRT type, an LCD type, or any other type of color or monochrome display. Also provided with the computer 10 is a keyboard 13 for entering text data and user commands, and a pointing device 14 (such as a mouse) for processing objects displayed on the monitor 11. Data and user commands can also be entered with a hand held scanner at point of service (POS) terminals (not shown).

The computer 10 may include a computer-readable memory medium such as a rotating disk 15 for storing readable data. Besides other programs, the disk 15 can store application programs including web browsers by which the computer 10 connects to the Internet and the systems described below, according to one aspect of the disclosure.

The computer 10 can also access a computer-readable floppy disk storing data files, application program files, and computer executable process steps embodying the disclosure or the like via a floppy disk drive 16.

A modem, an integrated services digital network (ISDN) connection, or the like may also provide the computer 10 with a DSL/Cable/satellite connection (or Internet connection) 12 to the World Wide Web (“WWW”). An Internet connection 12 may be used to allow the computer 10 to download data files, audio files, application program files and computer-executable process steps embodying the disclosure.

FIG. 2 is a block diagram showing the internal functional architecture of the computer 10. As shown in FIG. 2, the computer 10 may include a central processing unit (CPU) 20 for executing computer-executable process steps and interfaces with a computer bus 21. Also shown in FIG. 2 are a WWW interface 26, a display device interface 27, a keyboard interface 28, a pointing device interface 29, an audio interface 23, a scanner interface 25, a printer interface 24, a video interface 22, and a rotating disk 15. The scanner interface 25 can connect to a check scanner or imager (not shown) and a fingerprint scanner (not shown).

As described above, the disk 15 may store operating system program files, application program files, web browsers, and other files. Some of these files may be stored on the disk 15 using an installation program. For example, the CPU 20 may execute computer-executable process steps of an installation program so that the CPU 20 can properly execute the application program.

A random access main memory (“RAM”) 30 may also interface to the computer bus 21 to provide the CPU 20 with access to memory storage. When executing stored computer-executable process steps from the disk 15 (or other storage media such as the floppy disk 16, shown in FIG. 1, or the WWW connection 12, shown in FIG. 1), the CPU 20 stores and executes the process steps out of the RAM 30.

Read only memory (“ROM”) 31 may be provided to store invariant instruction sequences such as start-up instruction sequences or basic input/output operating system (BIOS) sequences for operation of the keyboard 13.

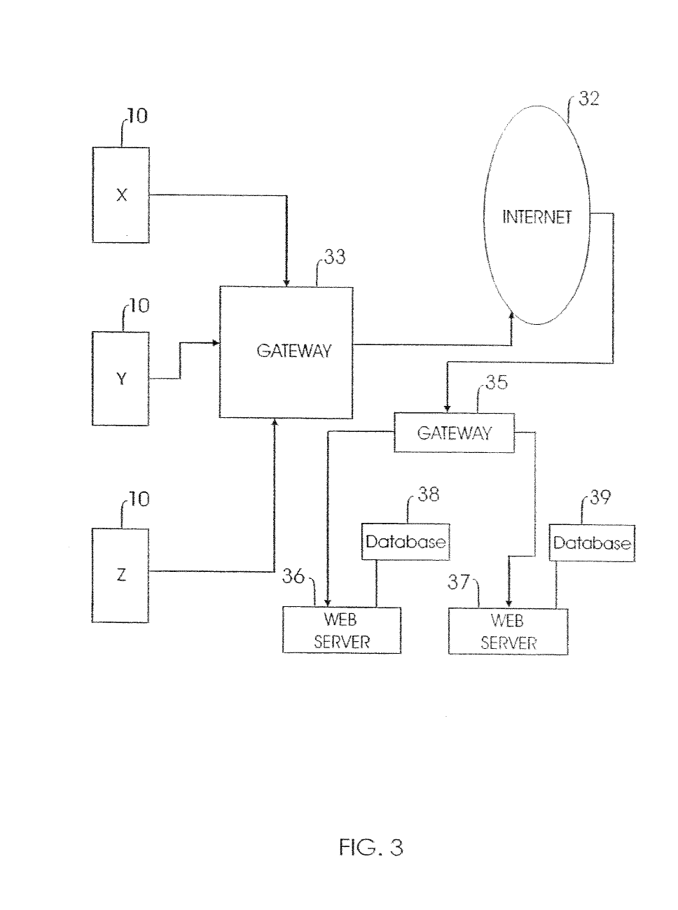

FIG. 3 shows a typical topology of a computer network with computers similar to computer 10, connected to the Internet. For illustration purposes, three computers X, Y, and Z are shown connected to the Internet 32 via the Web interface 26 (shown in FIG. 2) through a gateway 33, where the gateway 33 can interface N number of computers. The web interface 26 may be a modem, network interface card, or a unit for providing connectivity to other computer systems over a network using protocols such as X.25, Ethernet, or TCP/IP, or any device that allows, directly or indirectly, computer-to-computer communications.

It is noteworthy that the disclosure is not limited to a particular number of computers (or kiosks, as described below). Any number of computers (or kiosks) that can be connected to the Internet 32 or any other computer network may be used.

FIG. 3 further shows a second gateway 35 that may connect a network of web servers 36 and 37 to the Internet 32. The web servers 36 and 37 may be connected with each other over a computer network. The web servers 36 and 37 can provide content, including consumer information from a database 38 and/or 39. The web servers 36 and 37 can also host the proprietary point of purchase resource system, according to the disclosure.

The Internet 32 connects thousands of computers world wide through well-known protocols, for example, Transmission Control Protocol (TCP)/Internet Protocol (IP), into a vast network. Information on the Internet is stored world wide as computer files, mostly written in the Hypertext Mark Up Language (“HTML”). Other mark up languages, e.g., Extensible Markup Language (“XML”) as published by W3C Consortium, Version 1, Second Edition, October 2000, ©W3C may also be used. The collection of all such publicly available computer files is known as the World Wide Web (“WWW”).

The WWW is a multimedia-enabled hypertext system used for navigating the Internet 32 and is made up of hundreds of thousands of web pages with images and text and video files, which can be displayed on a computer monitor. Each web page can have connections to other pages, which may be located on any computer connected to the Internet 32.

In one embodiment of the disclosure, a proprietary point of purchase resource system that allows consumers to perform various services/transactions from a single source is provided. To utilize this resource system, a consumer uses a card that may be embedded with information and have pre-approved services/transactions that allow the consumer to perform the various services/transactions, particularly financial. Alternatively, the consumer information may be stored at a remote secured location and not on the card. The consumer information may include, but is not limited to, the address of the consumer, account information, a list of companies or services that the consumer has bills with, available minutes for telephone calls, and pre-paid money available for use as a debit card. The card may also contain a picture of the consumer and may be used to compare to a database of pictures of consumers utilizing this system in lieu of automatic facial recognition with cross referencing capabilities, for security purposes. The card is utilized with the system allowing the consumer to perform any selected services/transactions at one location.

Cards may include one or more smart chips or integrated circuits (“IC”) located within the body of the card to receive and store information. The ICs can be read-only or have read/write capability. The cards also contain interface means, which will depend on whether the card is a contact-type or contactless card. Contactless cards will contain an antenna structure for communication with an RF source, and typically include circuitry adapted for deriving operating power from the RF signal.

In addition to smart cards, magnetic cards, non-magnetic cards, pin based cards, signature based cards, open loop cards, closed loop cards and any other device having with the same capability may be utilized in conjunction with the resource system.

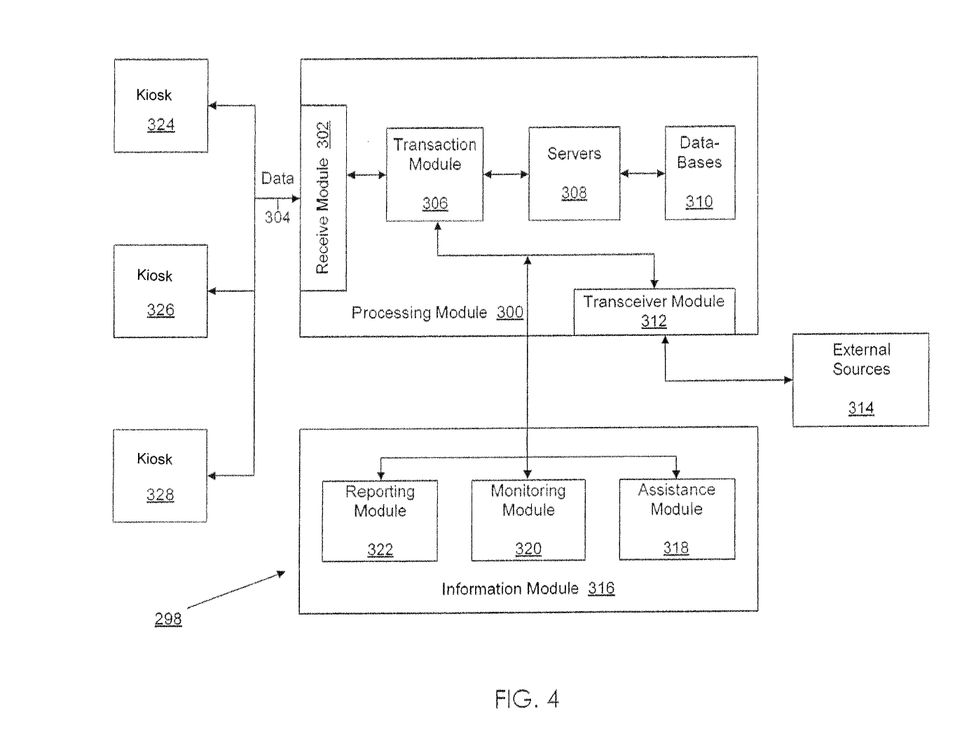

Turning to FIG. 4, a block diagram of a proprietary point of purchase resource system 298 for performing multiple financial services/transactions is illustrated. The system 298 includes a processing module 300 that includes a receiving module 302 for receiving data 304 from kiosks 324, 326, 328. The kiosks 324, 326, 328 are All-in-one web-based real-time financial services suite desktop self-service (or assisted-service) kiosks that allow the consumer to perform multiple financial services/transactions from a single source. The financial services/transactions may include, but are not limited to, check cashing, bill payment, cash-advance, money transfer, money order, exchanging foreign currency, ATM/POS (debit/credit processing), obtaining a pre-paid phone card, obtaining a pre-paid debit card, and others. Payment for these services/transactions may include, cash, credit cards, debit cards, checks, pre-paid cards, gift cards, and others. Although three kiosks are shown in FIG. 4, the number of kiosks is not limited to any specific number.

The receiving data 304 may include, but is not limited to, consumer requests, consumer instructions, consumer information, account information, and information about a provider, where a provider is a bank, credit card company, utility company, retailer or anyone (third party) that provides a good, service and/or information to the consumer.

To utilize the proprietary point of purchase resource system 298, a consumer uses one of the kiosks 324, 326, 328 at various locations, such as, convenience stores, liquor stores, gas stations, or any other location capable of maintaining a kiosk. The kiosks can be self-service where the consumer interacts with a terminal or monitor or the kiosk can include a clerk or agent to assist the consumer. In kiosks with a clerk, the kiosk may have a single monitor and/or dual monitors. Using a single monitor, the customer does not have access to the monitor and relies on the clerk to assist in completing the services/transactions. Using a dual monitor, the consumer and clerk both have access to a separate monitor. Thus, if the consumer needs assistance, the clerk can provide help. Each location can have multiple resource systems with single or dual monitors.

The receiving module 302 transmits the data 304 from the kiosks 324, 326, 328 to a transaction module 306 for analysis to determine the type of services/transactions being requested by the consumer. If additional information is needed, the transaction module 306 communicates with servers 308, which store the consumer's information in a database(s) 310. For example. if the consumer requests bill payment using a pre-paid account or signature base card account, the transaction module 306 communicates with a server(s) 308, which stores real time information about the balance of the consumer's Pre-paid card account in the database(s) 310. If the consumer has enough money in his/her pre-paid card account to pay the bill, the transaction module 306 transfers the money to external sources 314 via a transceiver module 312. The external sources 314 may include, but are not limited to banks, mortgage companies, utility companies, retailers and others.

The external sources 314 may also include credit bureaus; systems for verifying and validating the identify of the consumer using social security numbers, green card information, picture ID's and any other information relating to the consumer; systems for check verification, check guarantee systems and for biometric data collection and matching; and links into check image exchanges. If verification of information is needed, the transaction module 306 sends a request to the external sources 314, via the transceiver module 312, for verification of information provided by the consumer. The external sources 314 verify the information and send a command/message/instruction/report back to the transaction module 306 and then back to the kiosk where the consumer made the request. The command/message/instruction/report includes: if the information is correct and details any information that is not correct.

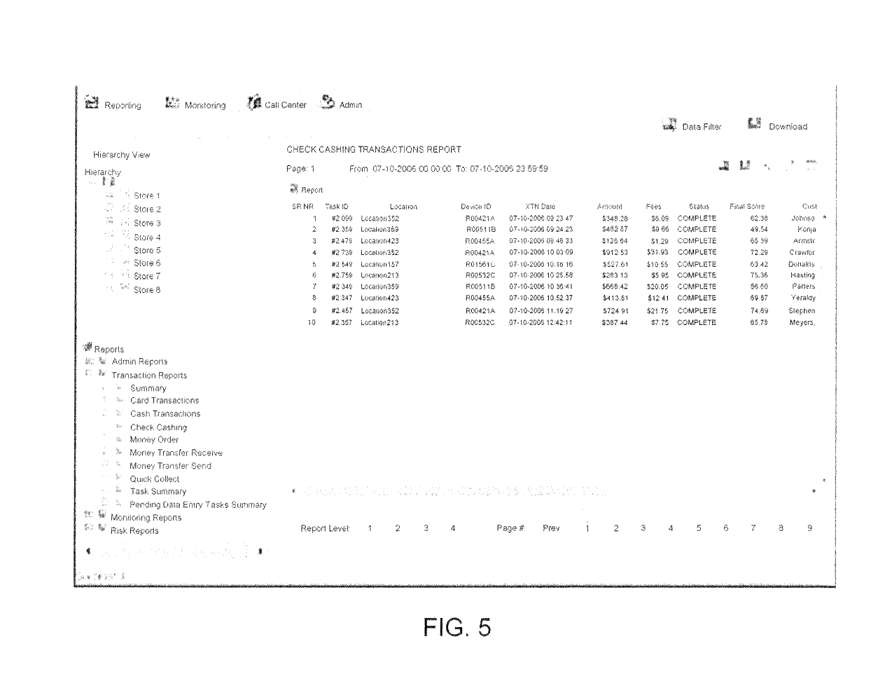

If the consumer requests a report (if applicable) on his transactions using the resource system 298, the processing module 300 sends a request for this report to a reporting module 322 within an information module 316. The reporting module 322 generates a report for the consumer, which is displayed on a monitor in a kiosk the consumer is using. FIG. 5 is a screen shot of a representative example of a transaction report generated from the consumer's services/transactions, according to one embodiment of the disclosure.

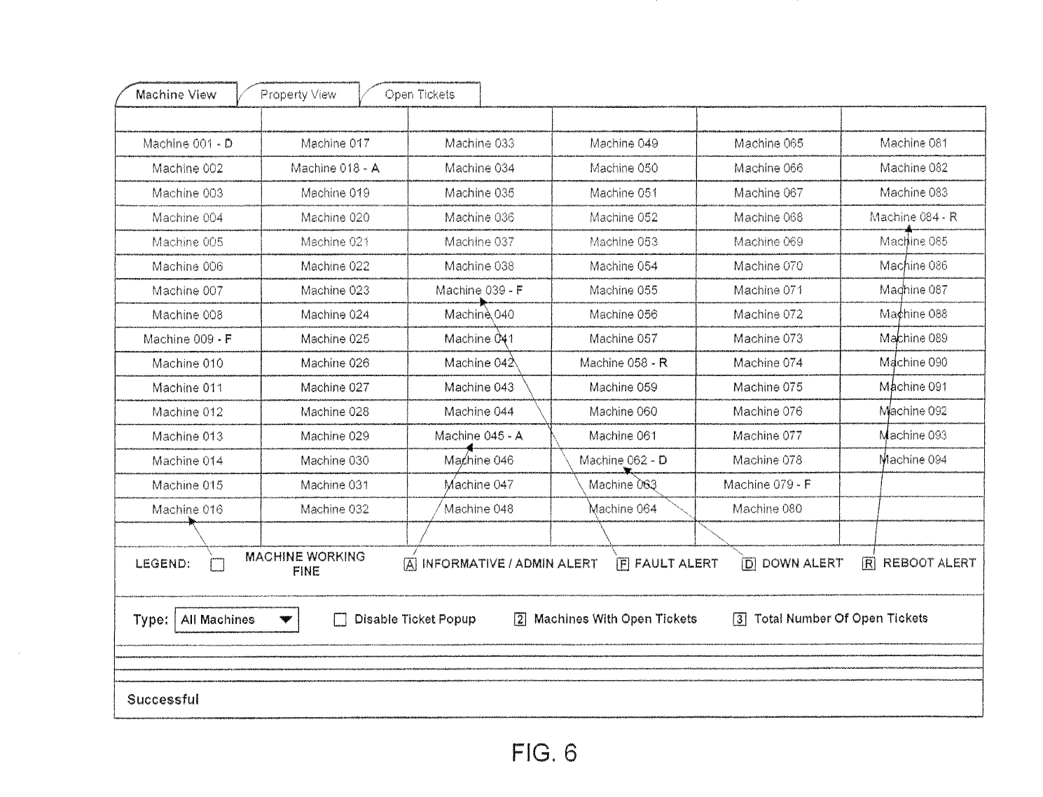

Each kiosk in the resource system can be monitored by clerks/agents for kiosks (or machines) that are not working properly. The kiosk sends a monitoring request to the monitoring module 320, within the information module 316, from the processing module 300. The monitoring module 320 generates a report for showing the status of each machine or terminal which is viewable from a single screen and in real-time. FIG. 6 is a screen shot of a representative example of a single screen monitoring with report capabilities of the resource system's machines or terminals (Kiosk), according to one embodiment of the disclosure. This allows the system's personnel to determine any problematic terminals.

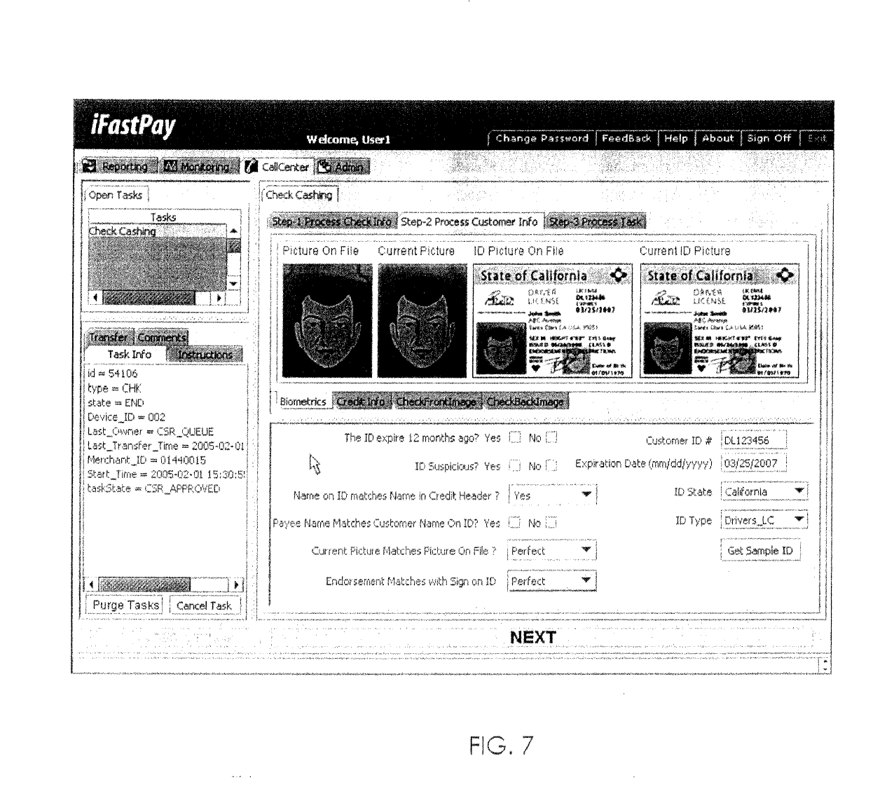

If the clerk/agent requests assistance with using the resource system 298, the processing module 300 sends a request to an assistance module 318 within the information module 316. The assistance module 318 generates a screen displaying information for the resource system's personnel to assist the agent. FIG. 7 is a screen shot of information used by the resource system's personnel to assist the clerk/agent, according to one embodiment of the disclosure. If the clerk agent is unable to complete a transaction, the personnel can cross check the consumer's facial image with the consumer's facial image stored in the database 310 and verify the consumer's account information to determine one possibility of why the transaction cannot be completed.

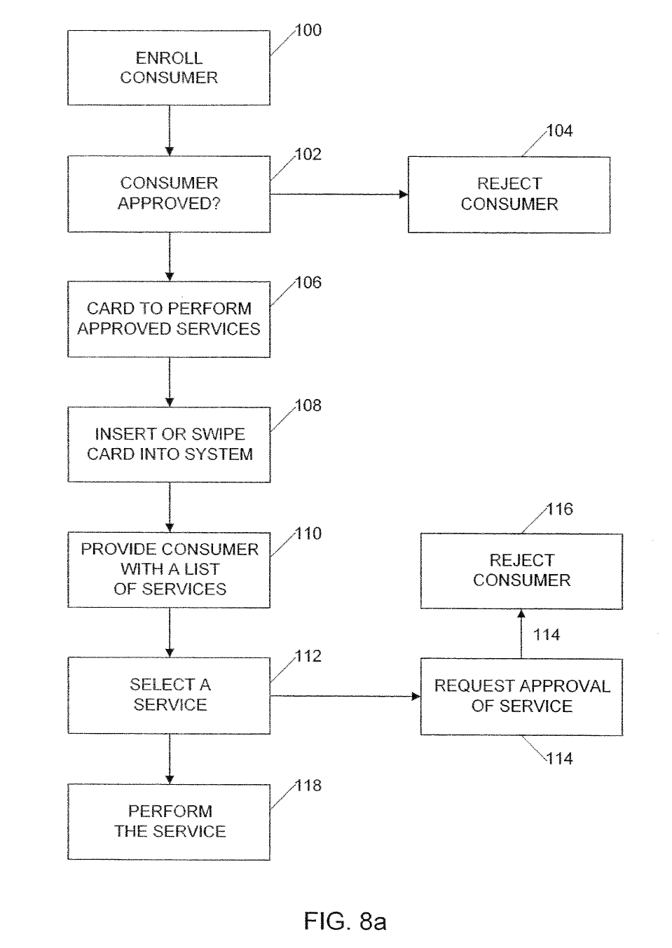

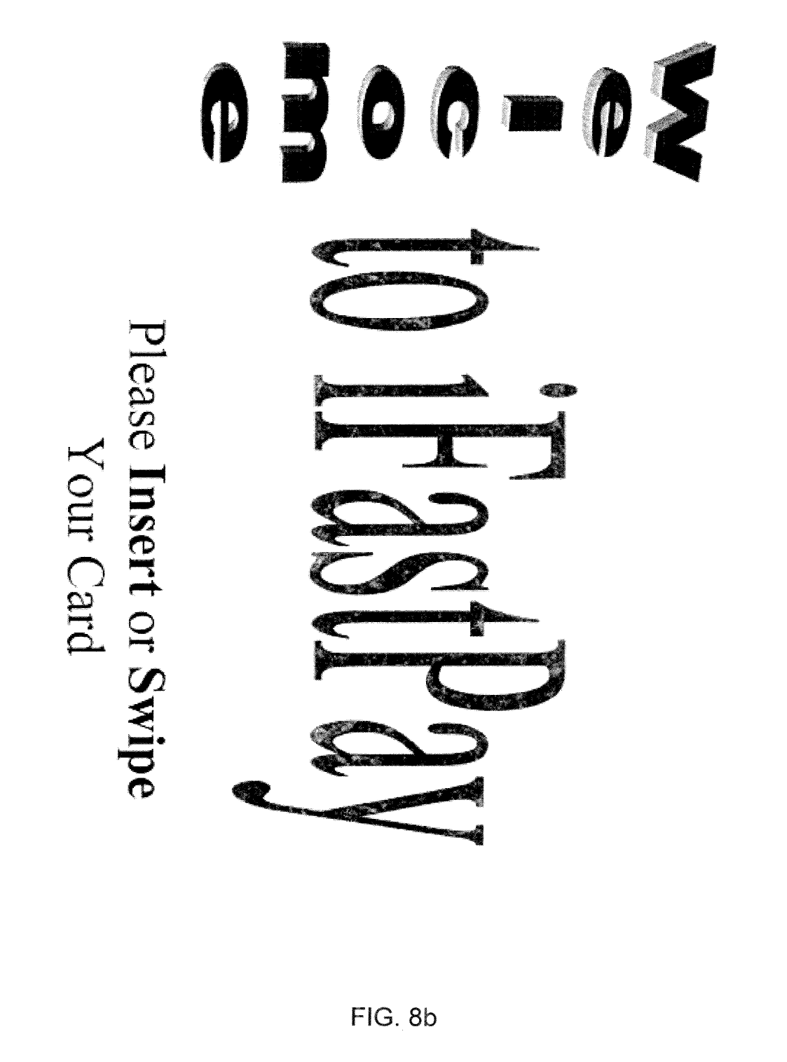

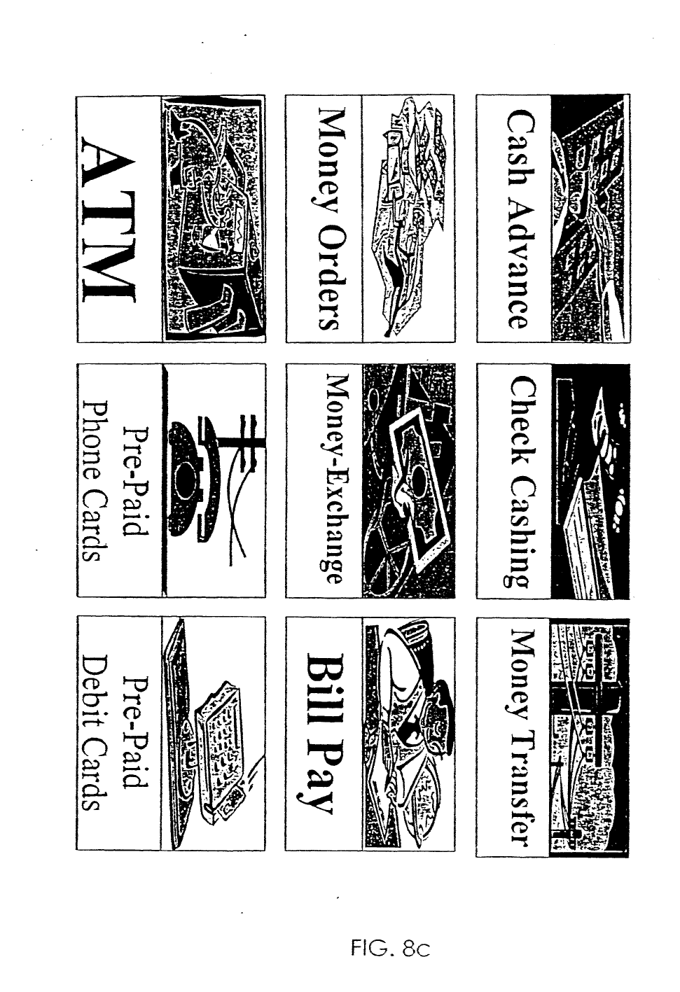

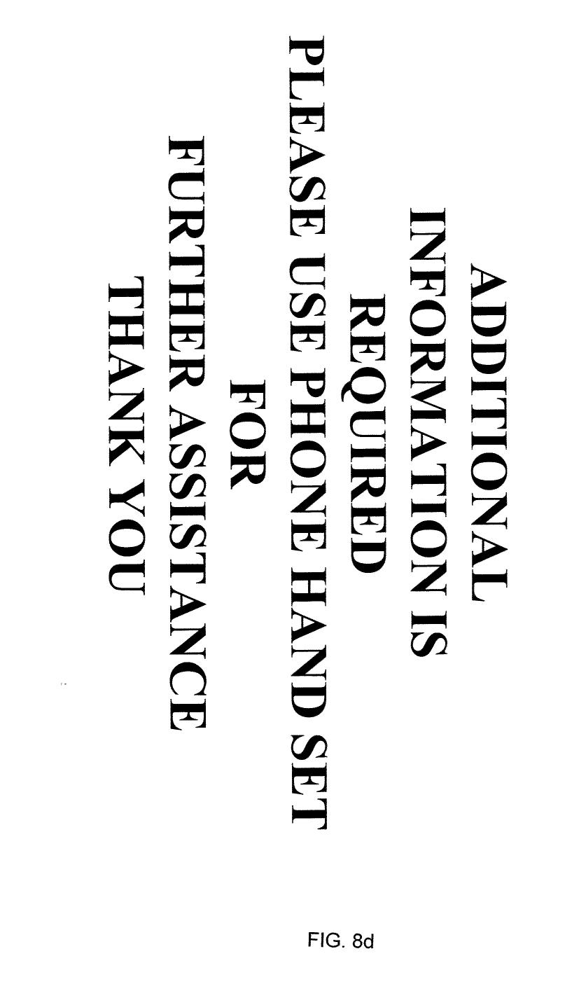

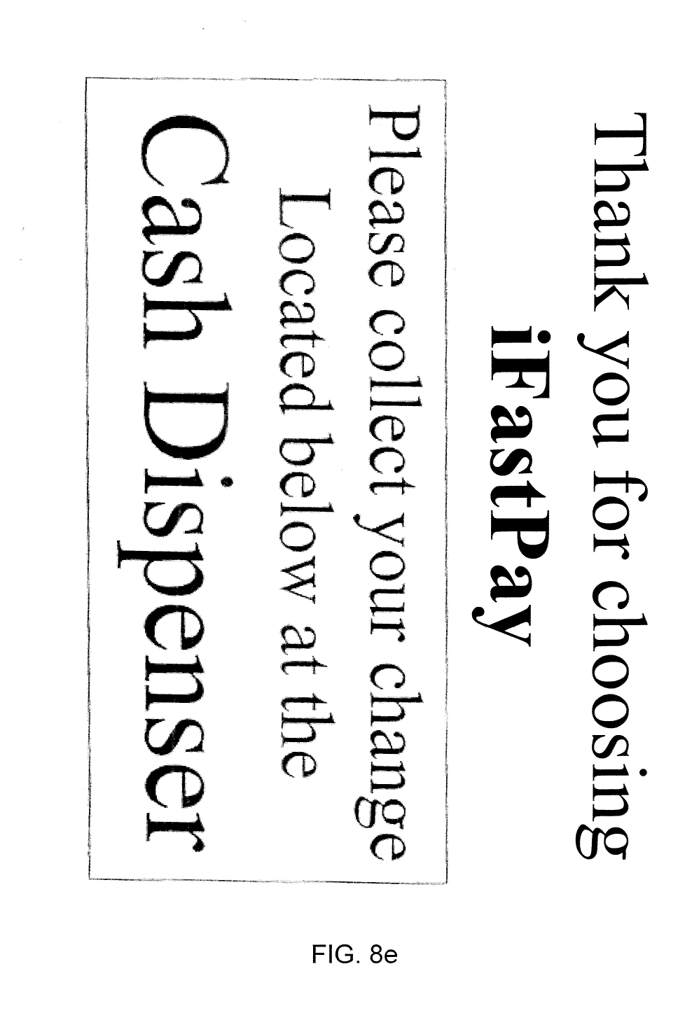

FIG. 8a illustrates a flow diagram of the method of utilizing the proprietary point of purchase resource system of the disclosure. First, in step S100, a consumer enrolls directly via an assisted kiosk or self-service kiosk or remotely, i.e. the Internet, or fills out an application providing information which may include, but is not limited to, the consumer's name, address, Social Security number, work and home telephone numbers, place of employment, salary bank account information. list of bills to pay on the system etc., and if applicable a preferred language to be greeted in. In step S102, a determination is then made, based on the information provided by the consumer. if the consumer has been approved for any services/transactions provided by the resource system. The enrollment process requires compliance with USA Patriot Act, OFAC guidelines etc., as well as a background check. In step S104, the consumer is rejected if the consumer cannot be approved for any of the services/transactions.

In step S106, if the consumer is approved, depending on the terminal, a card may be dispensed or provided by the agent/clerk. In step S108, if the agent/clerk has provided the card, the consumer must swipe/insert the card in a kiosk to register/activate the card that may include an associated pin number. In step S110, the card may be embedded with the consumer's information and include a list of services for which the consumer has been pre-approved. Alternatively the consumer information is stored at a remote secured location (server).

Each consumer that is approved may not be approved for all available services/transactions. Available services/transactions may include. but are not limited to, obtaining a cash-advance, cashing a check, wiring money obtaining a money order, exchanging foreign currency, paying bills, withdrawing money from an ATM, obtaining a pre-paid phone card, obtaining a pre-paid debit card and others. All qualifying consumers will be automatically approved for some services/transactions, such as bill payment, money transfer, money order and any service/transaction that does not require additional verification for approvals.

Additionally, the card may contain a picture of the consumer. The consumer is then provided with the card, which will allow the consumer to access any available resource system depending on the type of card. If the card provides ATM/Debit functionality, the card may be used at other associated networks, such as Star, Green dot as a convenience). To access the resource system, the consumer swipes/inserts the card into the system and the system requests the consumer enter a pin or access number for security purposes, in step S108. Upon verification of the pin or access number, the system may greet the consumer in the language the consumer indicated on the enrollment/application process. FIG. 8b illustrates an example of a screen shot that requests the consumer to swipe/insert a card, according to one embodiment of the disclosure. English is the default language unless another language is requested on the application/monitor. The consumer is greeted by a screen shot on a display screen, and may also be greeted with voice commands. If the consumer is using a self-service kiosk, after the greeting. the system will display a list of services/transaction (in step S110) that the system is capable of performing for the consumer to select from. FIG. 8c illustrates an example of a screen shot generated after the consumer has successfully logged into the system, according to one embodiment of the disclosure.

Alternatively, if the consumer is using an assisted kiosk, the consumer will not see a list of the approved services/transactions. Instead, the clerk assisting the consumer will ask the consumer which services/transactions he/she would like to perform.

From the list, the consumer is prompted to choose a service/transaction to be performed. Once the consumer selects a service/transaction in step S112, the system determines if the consumer is pre-approved for that service/transaction based upon the information that may be stored on the card or stored at a remote secured location (server). If the consumer requests a service/transaction that has not been pre-approved, the consumer is told that additional information is needed and must request approval of the denied service/transaction in step S114. If the consumer is using an un-assisted (self service) kiosk, the consumer may utilize a phone hand set on the system for further assistance. Alternatively, if the consumer is using an assisted kiosk, the consumer may be assisted by an agent/clerk.

FIG. 8d illustrates an example of a screen shot generated if the consumer is not pre-approved for the service/transaction that was selected, according to one embodiment of the disclosure. This expedited request, in step S114, may then be made using the phone hand set that may be provided with the system (Other alternatives may include a 800 number, Internet or direct links from the system). Having a phone hand set to request approval of additional services/transactions reduces the need of a clerk/agent and maintains crucial transactions at the back end to maintain security. (Back end processes must have all levels of security pre-installed.) The approval either can be automated or through a person at the other end of the line. If the consumer is rejected for the service/transaction in step S116, the consumer is given the option of choosing another service/transaction in step S112 or ending the service/transaction. If the consumer decides to end the transaction, the card may be retuned to a clerk/agent. If the consumer selects a pre-approved service/transaction in step S112, the pre-approved service/transaction is performed in step S118.

If the consumer selects the cash advance service/transaction, a series of verifications using the system primarily on the back end and upon approval within seconds a check in United States dollars is provided. This check can be cashed at any location that cashes checks. Alternatively, the consumer can request that the cash advance be credited to the card account, which can be debited as an ATM/debit transaction. Depending upon the relationship of the retailer with the system, a fee may be displayed for the consumer to either accept or reject the transaction.

If the consumer selects the check cashing service, the system first verifies the card, Pin number and requests that the check be inserted (or be provided to a clerk if utilizing the Assisted Platform). (Check guarantee service capabilities are an option.) In addition to the check verification, a camera may cross check the consumer's facial image with the consumer's facial image stored in a database. The system may then verify the validity of the check to make sure it isn't counterfeit, there hasn't been a stop payment, the date for cashing hasn't passed, etc. Once the validity has been verified, the system may verify the amount on the check or may prompt the clerk/agent to input the information in the assisted platform. Depending upon the relationship of the retailer with the system, a fee may be displayed for the consumer to either accept or reject the transaction. The system may stamp the check acknowledging it has been cashed and the check is held with the retailer on file for a period months or years if the agent is utilizing the Check-21 process “electronic deposit”. The retailer may receive the credit, or fee, electronically if utilizing the check-21 solution.

The system, or a clerk/agent if available, will dispense the money to the consumer. FIG. 8e illustrates an example of a screen shot instructing the consumer to collect money from a cash dispenser, according to one embodiment of the disclosure. Alternatively, the money may be credited to the consumer's card and be debited as an ATM/debit transaction. The consumer can also choose to receive some of the money in cash and the rest of the money credited to the consumer's card. Depending upon the relationship of the retailer with the system, a fee may be displayed for the consumer to either accept or reject the transaction.

If the consumer selects the wire/money transfer service, the system first verifies the card and pin number then at that point may determine the amount of money the consumer has available on the card provided the card is an open-loop card. By utilizing a pre-approved service, the consumer does not have to fill out any forms at a counter (this applies at repeat process, “the second time”), as is required by other businesses that provide the service of wire/money transfer. The consumer transaction history will be handled on the back end, utilizing the card. Once a transaction is at the final stage, a clerk/agent or the system will request the money to be transferred, thus completing the transaction. The amount of money available to the consumer is reduced by the amount of money that is transferred if the consumer is paying via the card. Depending upon the relationship of the retailer with the system, a fee may be displayed for the consumer to either accept or reject the transaction. Alternatively, the consumer may pay with cash, a traditional approach.

If the consumer selects the money order service, the system first verifies the card and pin number and then may determine the amount of money the consumer has available on the card, provided the card is an open-loop card. This funds verification process may be conducted initially or towards the middle or the end of all similar transactions. The system has the ability to dispense money orders or a clerk/agent can perform this service. Money orders can be obtained from the money the consumer has stored on the card or money that the consumer inserts into the system. If a clerk provides the money order, the clerk will accept the money and dispense the money order. The clerk/agent can accept cash or utilize money available on the card (open-loop). If the money is taken from the money on the card, the amount of money on the card is reduced by the amount of the money order. Depending upon the relationship of the retailer with the system, a fee may be displayed for the consumer to either accept or reject the transaction.

If the consumer selects the money exchange service, the system first verifies the card and pin number. Once the card has been verified and the consumer tells the system/clerk/agent which country and foreign currency is to be exchanged, the system displays the current rate of exchange which may also include rates in U.S. dollars depending on the request/transaction and the system's fees to perform the transaction. Alternatively, a clerk/agent has the ability to inform the consumer of the current exchange rate and fee to complete the transaction. The fees can be applied against the consumer's available money on the card (open-loop) or the consumer can insert money into the system. Exact change may not be required and the system can provide change.

If the consumer selects the bill pay service, the system first verifies the card and the pin number, and then the system verifies information of the bills the consumer has set up to pay. This information includes the names and addresses of all the companies or services to be paid. The consumer instructs the system or agent/clerk which company to pay and how much to pay the card. If the money is taken from the money on the card (open loop), the amount of money on the card is reduced by the amount of the bill or bills that are paid. A transaction fee for each bill to be paid is charged. Depending upon the relationship of the retailer with the system, a fee may be displayed for the consumer to either accept or reject the transaction.

If the consumer selects the ATM service, the process is identical to the current ATM machine set up that is currently being utilized by other companies. This service is being provided as a form of revenue. The system will offer the consumer the ability to place money in the consumer's account and shall have the ability to use the card issued as an ATM/debit card at any of the system's locations.

If the consumer selects the pre-paid phone card service. the system first verifies the card and the pin number and then the consumer or agent/clerk will use a Pin Pad/card reader that is part of the system to replenish the card with minutes as instructed by the system. The user inserts or swipes, depending on the system, the card into the Pin Pad/card reader and the consumer is prompted to select a vendor/carrier and the number of minutes to add to the card and is provided with the cost of adding the pre-selected amount of minutes along with the transaction fee. The system, or a clerk/agent. can accept cash, or utilize the consumer's money available on the card (open-loop). If the money is taken from the consumer's money on the card, the consumer's amount of money on the card is reduced by the cost of the minutes added to the card as well as the transaction fee. Depending upon the relationship of the retailer with the system, a fee may be displayed for the consumer to either accept or reject the transaction.

If the consumer selects the gift or loyalty cards (closed loop or open loop), the consumer or agent/clerk will use the Pin Pad/card reader that is part of the system to register the card and load with funds. The consumer inserts/swipes the card into the Pin Pad/card reader and the consumer is prompted to select the amount of money to be added to the closed loop cards. The system, or a clerk/agent, can accept cash to be added to the card. Also, if the consumer is already enrolled he/she can also load funds to any open loop card utilizing the self service or assisted system.

The system, in one embodiment of the disclosure, has the ability to perform the same services that a clerk/agent can perform. In addition to providing the consumer with a single source of performing multiple financial service/transactions the system provides the consumer with many additional advantages. First, all forms of money transactions that traditionally require paper will be converted into a paperless process via the card technology. Second, the system has the ability to be widely available and convenient. Kiosks can be placed at any corner market, convenience store and any retailer in residential, industrial and business areas where people work and live. Third, the system provides consumers who do not have bank accounts, credit cards, etc. the access to day to day money transactions/exchanges that they normally would not have access to and at the enrollment stage may provide the consumer with a pin based, open loop card which may include an option to upgrade to a signature based open loop card. Fourth, the system saves time in that it allows consumers to quickly perform multiple tasks in one location that may typically require human assistance. Fifth, the system is user friendly and intuitive. It has a simple step-by-step instructional process and directs the consumer and agent/clerk alike, if any errors are made, on the display screen of the system. In another embodiment, the errors may be presented via voice commands. Sixth, the system is saves space. The system may take the place of ATM machines and the like, which take up a large amount of room from the business, which can otherwise be used for an additional profit center. The system will save counter-top space if utilizing the counter-top assisted Kiosk. Finally, the system is language friendly. The consumer can choose the language the consumer prefers to be greeted in.

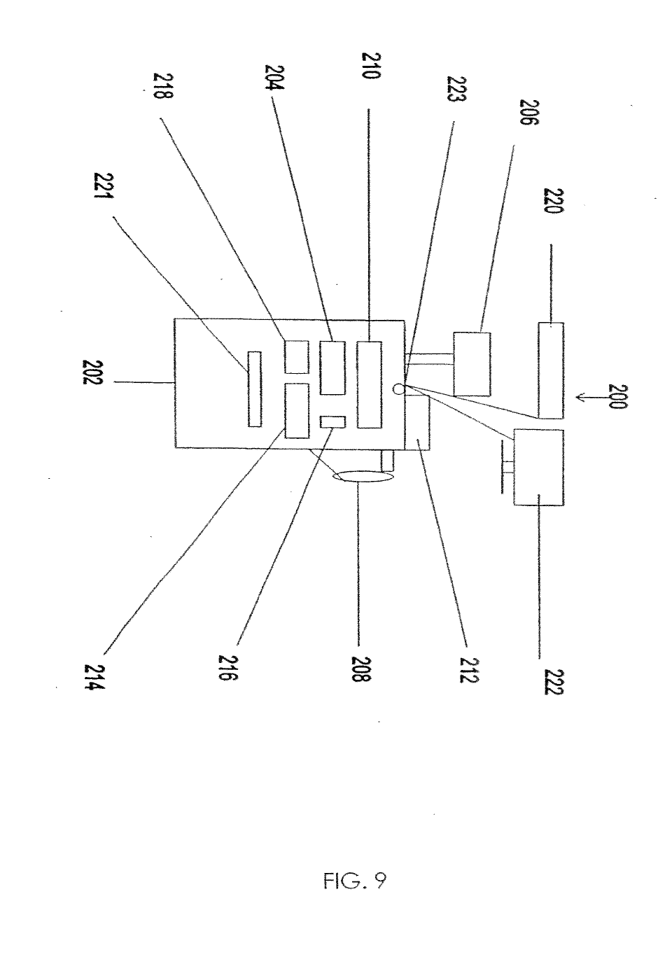

Turning to FIG. 9, one embodiment of a device or kiosk 200 utilized in the system is illustrated. Each device 200 includes a computing system connected to a network as described above with reference to FIGS. 1-3. As a result, all devices 200 are linked together in a network real-time and web-based. The device is made of secure cabinetry 202 providing security for the cash, checks and other information that may be stored inside. To utilize the system, a consumer either inserts a card into the Pin Pad/card reader 204 or passes (swipes) the card by the Pin Pad/card reader 204, depending on whether the card is contact or contactless. Once the Pin Pad/card reader 204 reads the card and verifies the associated pin number (open-loop), the consumer is greeted with a message on the touch screen 206 which may include the consumer's preferred language. The consumer is then provided a list of services to select from on the touch screen 206 (self-service platform). Alternatively, if the consumer is using an assisted kiosk, the consumer will not see a list of the approved services/transactions. The clerk/agent assisting the consumer will ask the consumer which services/transactions he/she would like to perform.

From the list. the consumer selects the service/transaction to be performed. If the consumer is not pre-approved for the service/transaction that has been selected, the consumer can utilize a phone hand set 208 or other options that may be provided to seek approval for the service/transaction. The device or kiosk 200 also comprises a check acceptor (check imaging) 210 for inserting a check to be verified for cashing, a cash acceptor 212 for accepting cash needed to perform a service/transaction, a money order dispenser (the device may be a combination of a printer and money order dispenser) 214 for dispensing money orders that have been purchased, a magnetic strip reader 216 for reading an ATM/POS Debit or a closed looped card, a camera 223 that may cross check the consumer's facial image with the consumer's facial image stored in a database, a scanner for scanning a consumer's fingerprint to verify identity, a printer 218 for printing the consumer a receipt and a cash dispenser 221 for dispensing cash. (The system may use a “recycler” for accepting/dispensing cash). The system also contains a keyboard 220 and a second touch screen monitor 222 that are used by clerks in systems that have the ability to utilize a clerk (The dual screen platform is only for the assisted counter-top kiosk).

Although one embodiment of the disclosure has been described above by way of example only, it will be understood by those skilled in the field that modifications may be made to the disclosed embodiment without departing from the scope of the disclosure, which is defined by the appended claims.

1. A method for performing multiple financial services from a single source system, comprising:
enrolling a consumer in the single source system;
determining if the consumer is approved for at least one of the multiple services;
establishing an account for the consumer if the consumer has been approved for at least one of the multiple services;
providing the consumer with a card to access the at least one multiple services;
engaging the card with the system;
providing the consumer with a list of multiple services to select from;
selecting a service from the list of multiple services and determining if the consumer is pre-approved for the selected service; and
performing the selected service if the consumer is pre-approved for that service.

2. The method of claim 1, wherein the single source system is a point of purchase resource system; and wherein the point of purchase resource system recognizes the consumer upon engaging the card with a card reader in the resource system.

3. The method of claim 1, wherein the consumer's information includes the consumer's Social Security number, green card information, photo, home number and work number.

4. The method of claim 1, wherein the consumer's information includes a list of businesses that may require payment by the consumer.

5. The method of claim 1, wherein if the consumer selects a service that the consumer is not pre-approved for, the consumer can expedite a request for approval utilizing a landline phone and if approved, the service is automatically available to the consumer.

6. The method of claim 1, wherein the available services are selected from a group consisting of pre-paid debit card, cash advance, check cashing, wire/money transfer, money order, money exchange, bill pay service, ATM/POS Debit, pre-paid phone card, gift cards, and loyalty cards.

7. The method of claim 3, wherein the consumer pays for the selected service with money stored on the card and the cost of the selected service is deducted from the money stored on the card.

8. The method of claim 1, wherein the consumer pays a transaction fee for each selected service.

9. The method of claim 2, further comprising the steps of:
inserting a check to be cashed into the point of purchase resource system; and
instructing the point of purchase resource system to conduct a series of verifications of the check.

10. The method of claim 9, wherein the money is dispensed from the point of purchase resource system.

11. The method of claim 9, wherein the money is added to the consumer's account on the card.

12. The method of claim 1, wherein the selected service is a cash advance and the amount of cash advance to the consumer is based upon the consumer's approved line of credit.

13. The method of claim 1, wherein the consumer can insert cash into the point of purchase resource system to increase the amount of money on the consumer's account or add minutes to the card.

14. The method of claim 1, wherein the card is inserted into a card reader in the system.

15. The method of claim 1, wherein the card is swiped into a card reader in the system.

16. The method of 1, wherein the system provides step by step instructions on how to utilize the services.

17. The method of claim 1, wherein the card is selected from the group comprising a smart card, an open loop card, a closed loop card, an ATM card, a debit card, a phone card and a magnetic card.

18. The method of claim 14, wherein the point of purchase resource system is self-service.

19. The method of claim 14, wherein the point of purchase resource system provides is an assisted counter-top kiosk.

20. A point of purchase resource system that allows consumers to perform multiple financial services from a single source, the device comprising:
a housing;
a card reader for reading information from the card, located in the housing;
a touch screen, located on the housing, for selecting a service to perform;
a phone hand set, attached to the housing, for requesting an additional service that is not pre-approved;
a check acceptor, embedded in the housing, for accepting check to be cashed and a money order dispenser for dispensing money orders;
a scanner, embedded in the housing, for capturing a consumer s fingerprint to verify identity; and
a camera, attached to the housing for capturing a facial image of the consumer to verify identity.
